(19) United States
(12) Patent Application Publication
(10) Pub. No.: US 2020/0391330 A1
(43) Pub. Date: Dec. 17, 2020

(54) Fastener For Affixing Magnetic Targets To A Nut Plate For Use In A System For Locating Non-Visible Objects

(71) Applicant: AVX Electronics Technology Limited, Cambridge (GB)

(72) Inventor: Richard David Hughes, Laindon (GB)

(21) Appl. No.: 16/897,406

(22) Filed: Jun. 10, 2020

Related U.S. Application Data
(60) Provisional application No. 62/861,668, filed on Jun. 14, 2019.
(60) Provisional application No. 62/870,886, filed on Jul. 5, 2019.

(51) Int. Cl. B23P 19/00

(52) U.S. Cl. CPC B23P 19/006

(57) ABSTRACT

A fastener for coupling a magnetic target to a nut plate base is provided. The fastener includes a body defining an opening. Furthermore, when the fastener is coupled to the nut plate base, the opening is aligned with an opening defined by the nut plate base and configured to accommodate a floating nut.

### PRIORITY CLAIM

The present application claims the benefit of priority of U.S. Provisional App. No. 62/861,668, titled “A Fastener for Affixing Magnetic Targets to a Nut Plate for use in a System for Locating Non-Visible Objects,” having a filing date of Jun. 14, 2019, which is incorporated by reference herein. The present application also claims the benefit of priority of U.S. Provisional App. No. 62/870,886, titled “A Fastener for Affixing Magnetic Targets to a Nut Plate for use in a System for Locating Non-Visible Objects,” having a filing date of Jul. 5, 2019, which is incorporated by reference herein.

### FIELD

The present disclosure relates generally to a fastener for affixing magnetic targets to a nut plate for use in a system for locating non-visible objects.

### BACKGROUND

There are many situations where it is desired: to locate something accurately, although the item in question is not visible. A simple example is to locate the position of a load-hearing member in. a partition wall made of a wooden frame to either side of which sheets of plasterboard are attached. If it is desired to fix something to the wall, e.g. using a hook, it is necessary to ensure that the hook, e.g. screwed into the wall, goes into part of the timber support rather than into the plasterboard, from which it will be easily removed when a load is applied because plasterboard is not particularly strong. Conventional methods, such as tapping the wall with a knuckle to determine the location of the supporting wooden frame members do not give particularly accurate results and require skill. Making, a pilot hole through the plasterboard and inserting a piece of bent wire through it into the cavity likewise is not easy to carry out simply, and although location, e.g. using a small magnet, of the usually iron nails which hold the plasterboard to the wooden. structure can be employed, again the results tend to be rather inaccurate, although this last approach does have the advantage of avoiding trying to insert a hook where there is already a nail underneath.

These systems are useful in the building trades, but are not adapted for use in situations where dimensions are subject to tight tolerance limits, some of which are particularly critical in manufacture, For example, in the manufacture of aircraft, a widely used technique is the application of a metal plate or skin to an underlying frame, for example made of ribs or spars. In order to ensure a firm connection between the skin and the rib or spar, a technique commonly employed is that of fastening the two together, e.g. with a rivet or special fastener. In order to do this, apertures in the skin and the rib or spar need to coincide and this coincidence needs to be particularly accurate since if there is inaccuracy, riveting may be rendered more difficult, or even impossible and inadequately-fitting or misapplied rivets can become loosened when the aircraft is in service leading to potentially catastrophic failure. Accordingly, the requirements for accurate matching of the hole in the skin with the hole in the rib or spar are very stringent and the penalty for inadequate accuracy may well be the failure of the finished assembly to meet the required rigorous safety standards, leading to the entire assembly having to be recycled. Although if the rib or spar has pre-formed holes, it is notionally possible to use each of those holes as successive guides for making holes in an applied skin, this is usually awkward and sometimes practically impossible for reasons of space, and inaccuracies creep in. Additionally, drilling a hole through the skin from inside does not always provide accurate alignment of the hole in the skin, so that its axis runs exactly perpendicular to the surface of the skin. This is a particular problem where the skin is varying in thickness, e.g. tapering from a thick to thin section. Working from the outside, however, i.e. working with the skin between the operator and the spar or rib means that the positions of the holes cannot be seen. Attempts to use templates to overcome this have not been successful.

### SUMMARY

Aspects and advantages of embodiments of the present disclosure will be set forth in part in the following description, or may be learned from the description, or may be learned through practice of the embodiments.

In one aspect, a fastener for coupling a magnetic target to a nut plate base is provided. The fastener includes a body defining an opening. Furthermore, when the fastener is coupled to the nut plate base, the opening is aligned with an opening defined by the nut plate base and configured to accommodate a floating nut.

In another aspect, a method for coupling a magnetic target to a nut plate base is provided. The method includes coupling a fastener to the nut plate base such that an opening defined by the fastener is aligned with an opening defined by the nut plate base. The method further includes coupling the magnetic target to the fastener such that a projection of the magnetic target is disposed within the opening defined by the fastener.

In yet another aspect, a nut plate assembly is provided. The nut plate assembly includes a nut plate base defining an opening configured to accommodate a floating nut. The nut plate assembly further includes a fastener. The fastener includes a body defining an opening. The fastener is removably coupled to the nut plate base such that the opening defined by the body thereof is aligned with the opening defined by the nut plate base. The nut plate assembly further includes a magnetic target positioned within the opening defined by the fastener.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 is a diagrammatic illustration of a section through a sensor array in accordance with a first embodiment of the present disclosure, the sensor array being located adjacent an opaque metallic skin in turn located adjacent a pre-drilled spar;

FIG. 2 is a diagram showing two alternative approaches to providing the variable strength magnetic field;

FIG. 3 is a diagrammatic perspective view showing apparatus in accordance with the first embodiment according to the present disclosure;

FIG. 4 is a block diagram showing the electronics arrangements in the apparatus of the first embodiment;

FIG. 5 is a diagram of apparatus in accordance with the present disclosure;

FIG. 6 is a diagram of a component of the apparatus illustrated in FIG. 5;

FIG. 7 is a first example of a sensor head in accordance with the present disclosure;

FIG. 8 is a second example of a sensor head in accordance with the present disclosure;

FIG. 9 is a third example of a sensor head in accordance with the present disclosure;

FIG. 10 provides a perspective view a floating nut plate according to example embodiments of the present disclosure;

FIG. 11 provides a perspective view of a nut plate assembly according to example embodiments of the present disclosure;

FIG. 12 provide an exploded view of a nut plate assembly according to example embodiments of the present disclosure;

FIG. 13 depicts use of system for detecting location of non-visible objects to detect a nut plate base according to example embodiments of the present disclosure;

FIG. 14 provides a perspective view of a fastener of a nut plate assembly according to example embodiments of the present disclosure;

FIG. 15 provides a rear perspective view of the fastener of FIG. 14 according to example embodiments of the present disclosure;

FIG. 16 provides a perspective view of a fastener of a nut plate assembly according to example embodiments of the present disclosure; and

FIG. 17 provides a flow diagram of a method for coupling a magnetic target to a nut plate base according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to apparatus, systems and methods for affixing magnetic targets to a floating nut plate for use in a system for locating non-visible objects. Floating nut plates can be used in locations where it is required to replace or remove skin plans on aircraft. Example locations in which floating nut plates can be used can include, without limitation, the wings of an aircraft, inspection hatches, fuselages, and a nacelle or cowling associated with a gas turbine engine mounted to the aircraft.

Conventional floating nut plates include a nut plate base, a movable threaded component, and a clip configured to secure the movable threaded component to the nut plate base. The clip and the movable threaded component can each be formed from magnetic material. However, the system for locating non-visible objects cannot be used to locate the floating nut plate, because of the clip and the moveable threaded component. Furthermore, although the clip and the movable threaded component can be removed from the nut plate base, the system for locating non-visible objects cannot be used to locate the nut plate base, because the nut plate base is not made of magnetic material or magnetic material having sufficiently low magnetic properties such that the nut plate base cannot be detected by the system for locating non-visible objects.

Example aspects of the present disclosure are directed to fasteners that can be used to affix a magnetic target to the nut plate base so that the system for locating non-visible objects can be used to locate the nut plate base. Example fasteners can define an opening and can be removably coupled to the nut plate base such that the opening is aligned with an opening defined by the nut plate base. Furthermore, a magnetic target of the system for locating non-visible objects can be coupled to the nut plate base via the fasteners. More specifically, the opening defined by the fasteners can be configured to accommodate at least a portion of the magnetic target. In this manner, the system for locating non-visible objects can determine a location of the nut plate base and, more specifically, the opening defined by the nut plate base.

When the location of the opening defined by the nut plate base is located, a hole can be drilled in the aircraft structure that is aligned with the opening defined by the nut plate base. A drill bit used to drill the hole can push the magnetic target such that the magnetic target is no longer positioned within the opening defined by the fastener. In some implementations, the magnetic target can be coupled to a lanyard. In this manner, the magnetic target can be retained via the lanyard when the magnetic target is decoupled from the fastener via the drill bit.

In some implementations, the fastener can be integrally formed with the magnetic target of the system for locating non-visible objects. In this manner, the magnetic target can be directly coupled to the nut plate base. Furthermore, the magnetic target having an integral fastener can be decoupled from the nut plate base when pressed by the drill bit being used to drill the hole in the aircraft structure. When decoupled from the nut plate base, the magnetic target having the integral fastener can be retained via a lanyard that is coupled to the magnetic target via a suitable eye hook feature on the magnetic target.

The fasteners according to the present disclosure provides numerous technical benefits. For instance, the fasteners can be used to couple a magnetic target of the system for locating non-visual objects to a nut plate base. In this manner, the system for locating non-visible objects can be used to determine a location of the nut plate base. More specifically, the system can be used to determine a location of the opening defined by the nut plate base. In this manner, the system can be used to determine drill locations on aircraft structures using nut plates.

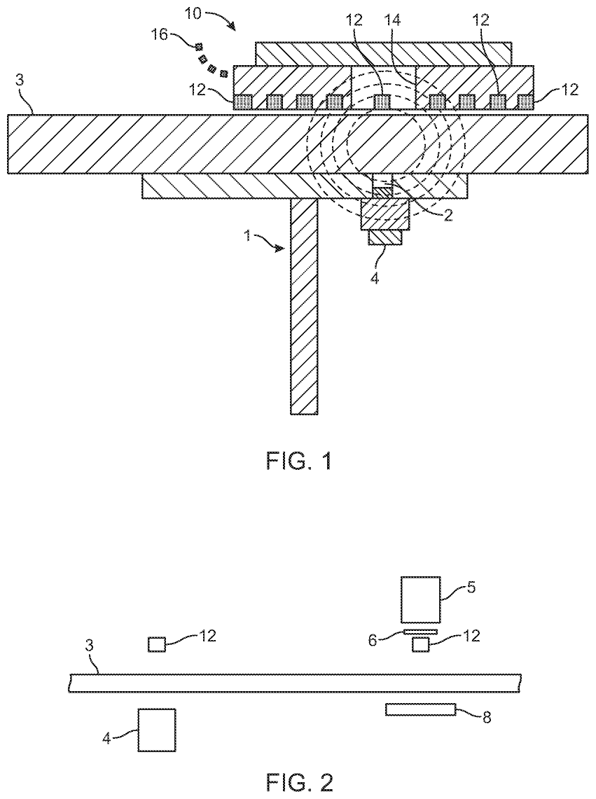

Referring now to the FIGS., FIG. 1 shows in extremely diagrammatic form, how holes in a spar on the far side of a metal cladding sheet can be detected. For the sake of only one hole 2 is shown in the fiat portion of a spar 1. As shown, a plate 3 (for example an alloy skin for a wing) which is to be attached to the spar is placed against it. In order to enable detection of the position of the hole 2, a magnet assembly 4 set in a suitable mounting is located relative to the hole 2 from below as shown in FIG. 1.

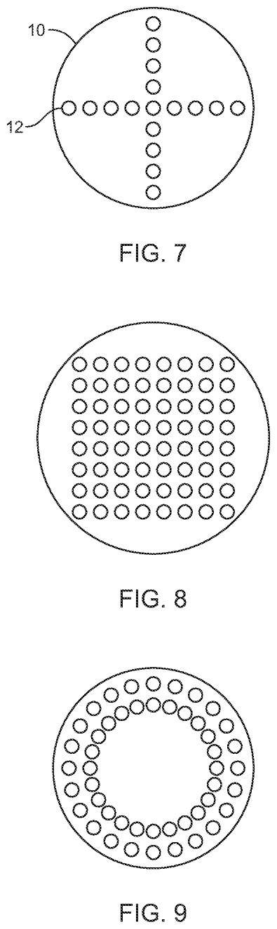

As shown, a sensor array 10 can be disposed on the plate 3. More specifically, a base member of the sensor array 10 can be positioned on the plate 3. In some implementations, the sensor array 10 can include a plurality of magnetic sensors 12 (further illustrated in FIG. 7). As shown, the plurality of magnetic sensors 12 can be disposed within the interior of the base member. As seen in the drawings, eight of the magnetic sensors 12 are seen spaced to either side of a central magnetic sensor 12. The eight are aligned in a row and the central magnetic sensor 12 is, counting from the end of the row of sensors perpendicular to the plane of the drawing, the fifth one. As shown, the wall defines an aperture 14 in the middle of the array.

Alternative arrangements of sensors are conceivable, and two further examples are illustrated in FIGS. 8 and 9. FIG. 8 shows an 8 by 8 array of 64 sensors (more or fewer sensors are possible) and FIG. 9 shows 48 sensors arranged in two concentric circles.

As will be appreciated, the end of the magnet assembly 4 inserted into hole 2 is the center location of a generally symmetric magnetic field having its maximum located in terms of the upper surface of plate 3 at the point on that upper surface which is precisely aligned with the axis of hole 2. At points on the upper surface of plate 3 more remote from that point, the magnetic field strength is less. The magnetic field strength at any point on the surface can be measured using a magnetic sensor. It should be appreciated that any other magnetic field strength sensor could be used, such as an eddy current based sensor.

The magnetic sensors 12 are connected via a suitable signal-carrying cable 15 to an evaluation electronics, for example in the form of a laptop computer or PDA. It will readily be appreciated that if the sensor array 10 is located as shown in FIG. 1 with the aperture 14 located coaxially with the hole 2, then the magnetic field strength will be greatest and of equal value at the positions of the Hall sensors radially closest to aperture 14, with the field strength detected by each of the sensors more remote from aperture 14 being less, and being lowest at the outermost ones.

If the sensor array 10 is shifted from its position in FIG. 1, the field strengths will vary at the individual magnetic sensors 12 and the signals from them can be appropriately analyzed to work out how far the axis of aperture 14 then deviates from the axis of hole 2. By moving the sensor array 10 to minimize that deviation, the aperture 14 may be aligned with hole 2 essentially seen from above as shown in FIG. 1. Aperture 14 may then, for example, have a drilling guide inserted into it, or, for example, a marking implement of some type so as to identify that point on the upper surface of plate 3 which lies on the axis of hole 2.

FIG. 2 shows diagrammatically two different ways of operating the system. Each can be used depending on the particular task involved. The system shown on the left of the drawing corresponds to the operation as illustrated in FIG. 1, with the magnet assembly 4 positioned on one side of the plate 3 which, as mentioned above, can heal aluminum alloy skin for an aircraft wing, and the magnetic sensor 12 located on the other.

However, the system may also be operated the “other way round”, as shown on the right of FIG. 2. In that alternative, a magnet 5 can be located behind the magnetic sensor 12, with a ferromagnetic diffuser plate 6 located between them. The magnetic field below magnetic sensor 12 as seen in the drawing is affected by a ferromagnetic “target” piece 8 located the other side of the plate 3. This may be a piece of ferromagnetic material such as soft iron or, for example, a disk or slug of molded plastics material loaded with iron powder or filings. This latter approach is of particular value in locating holes so that a bore concentric therewith may be drilled from above as seen in FIG. 2. Each hole in e.g. an aircraft wing spar, may have such a plastics slug fitted into it, and these then drop out or are drilled out each time a bore is made through the opaque sheet of material following the location of the hole and fixation of the base member carrying the magnetic sensor array, the machining guide, and, in this case, the magnets 5.

Referring now to FIG, 3, an example apparatus is provided for detecting pre-drilled holes 22 in a spar 20 when located behind a skin 21 which is to be fixed to the spar 20 by means of rivets. Each rivet needs to pass through a hole made in skin 21 and through one of the pre-drilled holes 22 in spar 20. The apparatus can include a main pneumatics and power supply equipment box 30, a unit 31 which, as can be seen, is held against the skin 21, and which contains the electronics described below and a display unit at a housing 32. Box 30 has a lead 37 for connecting to a source of electrical power.

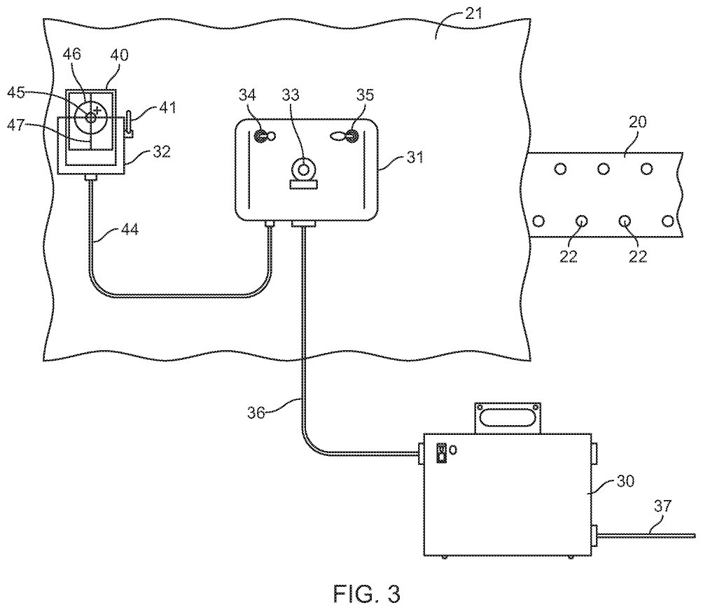

On the underside of the unit 31 and accordingly not visible in FIG. 3, is an array of magnetic sensors. These surround a drilling guide tube 33 in an appropriate arrangement, for example cruciform, though other arrangements can be contemplated. Unit 31 also carries two vacuum line switches 34, 35 which can be actuated by the user of the apparatus to hold unit 31 against skin 21, i.e. in fixed position relative thereto, and which can be adjusted to release the vacuum slightly so that unit 31 can be moved around on skin 21. Umbilical lead 36 provides air and power to unit 31 from the power supply equipment box 30.

Before using the apparatus to locate one of the pre-drilled holes 22 not visible behind skin 21, a magnet is placed in one of the pre-drilled holes 22 so that a symmetrical magnetic field spreads out through the skin 21 and its field strength can be detected adjacent the surface of skin 21 visible in FIG. 3 by means of the magnetic sensors on the underside of unit 31. Those sensors are connected to processing electronics located in unit 31.

By appropriate processing of the signals received from the individual magnetic sensors included in the array of magnetic sensors disposed on the underside of unit 31, the location of the maximum magnetic field strength point can be found and, more particularly, displayed on a display screen 40 set in housing 32. In some implementations, the display screen 40 can be a PDA and housing 32 can be a docking station. Housing 32 may be affixed by means of a suction cup to the visible side of skin 21 at any convenient point. Fixture is effected by a suction cup actuation lever 41 on housing 32 and the display screen 40 is connected via a signal cable 44 with the electronics in unit 31. As can be seen, the display screen 40 can display a pair of concentric circles 45, 45 and a fixed vertical and horizontal crossbar structure 47. The electronics are arranged to show on the display screen 40 the position of the point of maximum magnetic field strength. The fixed vertical and horizontal crossbar structure 47 is positioned such that it corresponds to the drilling guide tube 33, i.e. as unit 31 is moved, so concentric circles 45 and 45 on the display screen 40 move likewise. It is accordingly very straightforward, with the housing 32 being stationary but the unit 31 being movable. In this manner, the unit 31 can be moved into a position in which the smaller concentric circle 45 is precisely central relative to the fixed vertical and horizontal crossbar structure 47.

When the smaller concentric circle 45 is precisely center relative to the fixed vertical and horizontal crossbar structure 47, unit 31 may be clamped firmly in position on skin 21 and the drilling guide tube 33 can be used as a drilling guide to allow a bore to be made in skin 21 which is precisely perpendicular to the surface of skin 21 and Which is precisely coincident with the pre-drilled holes 22 in spar 20 which carried the magnet during the positioning process. The bore may accordingly be made, unit 31 taken out of the way, a rivet inserted and fixed in position, and the process then repeated for the purpose of drilling the next hole in skin 21 to align with the next aperture 22in the spar 20.

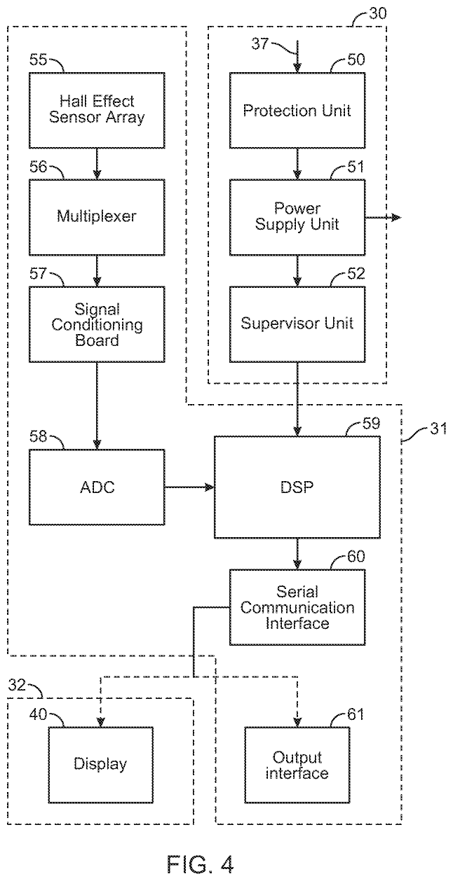

FIG. 4 shows a basic diagram of the electronics used in the apparatus shown in FIG. 3. The dashed boxes in FIG. 4 indicate which parts of the system are housed in unit 31, which on housing 32 and which are housed in the power supply equipment box 30. An input voltage supply fed via the lead 37 is fed via a suitable protection unit against over-voltage and over-current to a power supply unit 51. The protection unit 50 protects the power supply unit 51 from any transients and reverse polarity problems. The power supply unit 51 is basically designed to generate stable analogue digital power supplies for use with the magnetic sensor array in unit 31 and to provide a system voltage for powering the digital processing electronics itself.

Located on the output side of power supply unit 51 is a power supply supervisor unit 62 which is used to monitor the sensor voltage supply and to indicate, for example by flashing up a message on the display screen 40, if there is a problem.

As shown, the output of each of the magnetic sensors included in the magnetic sensor array 55 can be provided to a multiplexer 56 and signal conditioning board 57 which is provided with the necessary electronics to clean and stabilize the magnetic sensor voltage measured. The signal corresponding to the cottage selected by multiplexer 56 is fed to a high resolution analogue/digital convener 58 to provide a digital signal corresponding to the magnetic sensor voltage and this is fed in turn into a digital signal processing unit 59 which stores and processes the digital voltage signals corresponding to each of the magnetic sensors in turn. By appropriate programming, this can then calculate the position of the center of the magnetic field relative to the array itself and it can provide that information via a serial communication interface 60 to the display screen 40 located on housing 32. As noted with respect to FIG. 3, this graphical display presents the position of the sensor array relative to the magnet in a very easily comprehendible fashion. As will be discussed below in more detail, the electronics can include an output interface 61, which can be used to control any external apparatus, for example a monitoring computer or a robot control computer.

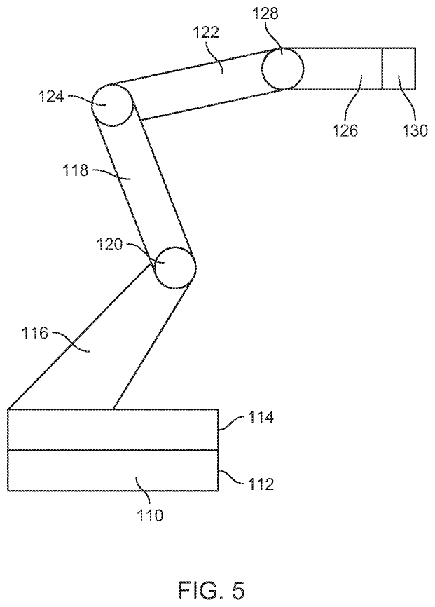

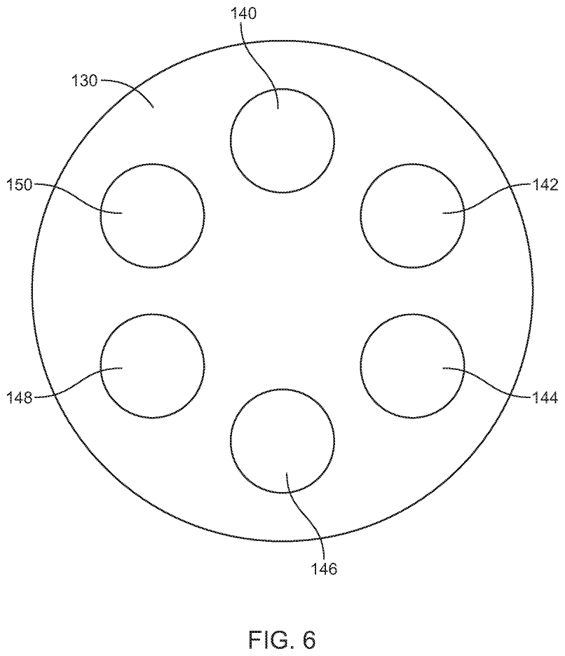

As illustrated in FIG. 5, an industrial robot 100 can include a base 110 having a static portion 112 fixed in use to a floor or the like, and a rotatable portion 114 operable to rotate above the static portion 112 under the direction of suitable drive means about a vertical axis in the fashion of a turntable. A base arm 116 can extend from the rotatable portion 114, at the distal end of which a first arm 118 is hingeably connected using an elbow hinge 120 set with a horizontal axis. A second arm 122 is then hingeably connected to the distal end of the first arm 118 with a further elbow hinge 124. A head 126 can then connected to the distal end of the second arm 122 with a ball joint 128.

In some implementations, each of the elbow hinges 120, 124 and the ball joint 128, can be under the control of suitable drive means as will be understood by the reader familiar with robotics. In particular, the industrial robot 100 will be under computer control, and the motion will be imparted by suitable stepping motors or the like, with positional control sufficient to ensure the accurate positioning of the head 126.

The magazine 130 is illustrated in further detail in FIG. 6. The magazine 130 is generally illustrated as being cylindrical, and is shown in end elevation in FIG. 6. Six head units are illustrated, which are spaced equiangularly about a central axis of the magazine. The heads comprise: a sensor array 140; a drill 142; a countersink drill 144; a polisher 146; a sealant dispenser 148; and a riveting tool 150.

The magazine 130 is rotatable about its own cylindrical axis (by drive means again not illustrated for reasons of clarity), to allow presentation of each of the six units in turn by rotation of the Magazine through increments of 60 degrees. The ohm head is thus able to perform each of the six operations involved in inserting a rivet in a designated point in a mechanical component, the point being indicated by way of a magnetic field generating object as previously described, or on the basis of detection of a hole in an object behind the skin to be drilled, with the magnetic field to achieve this being generated behind the sensor array in such a circumstance.

Thus, in this embodiment, the drilling axis is not coincident with the sensor array. In this embodiment, the drilling axis and indeed the countersinking axis) is displaced away from the sensor array, but by a fixed amount by virtue of the fixed relationship between the sensor array 140 and the drill 142.

It will be appreciated that this is but one example of a factory automation arm, or machine, which could serve to implement an embodiment of the present disclosure. A linear arrangement, including a linearly displaceable magazine, could also be provided. A gantry style robot could be used instead of an “arm” style machine. The level of artificial intelligence provided in such a robot is not an essential part of the present disclosure, as control electronics for the sensor, and thus for the magazine as a whole, should be in line with the electronics illustrated in FIG. 4 (with modification as appropriate to the implementation chosen by the designer).

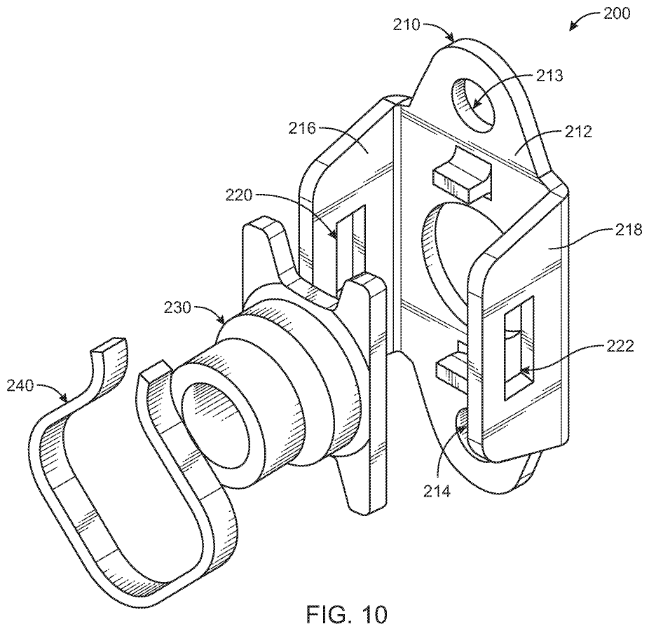

Referring now to FIG. 10, a floating nut plate 200 is provided according to example embodiments of the present disclosure. As shown, the floating nut plate 200 can include a nut plate base 210. The nut plate base 210 can include a body 212 defining a first mounting hole 213 and a second mounting hole 214. The first mounting hole 213 and the second mounting hole 214 can each be configured to accommodate any suitable type of fastener used to secure the nut plate base 210 to a workpiece. For instance, in some implementations the fastener used to secure the nut plate base 210 to the workpiece can be a rivet.

As shown, the body 212 of the nut plate base 210 can further define an opening 215 positioned between the first mounting hole 213 and the second mounting hole 214. It should be appreciated, however, that the opening 215 can be positioned at any suitable location on the body 212 of the nut plate base 210. For instance, in some implementations, the opening 215 can be offset relative to the first mounting hole 213 and the second mounting hole 214. It should also be appreciated that the opening 215 can be configured to accommodate a fastener used to secure a floating nut (not shown) to the nut plate base 210. In some implementations, the nut plate base 210 can include a first wing 216 and a second wing 218 spaced apart from the first wing 216. As shown, the first wing 216 and the second wing 218 can extend from the body 212 such that the first wing 216 and the second wing 218 are substantially perpendicular to the body 212.

As shown, the floating nut plate 200 can further include a movable threaded component 230 and a clip 240. The movable threaded component 230 can be secured to the nut plate base 210 via the clip 240. When the movable threaded component 230 is secured to the nut plate base 210 via the clip 240, a portion of the clip 240 can, in some implementations, extend into the aperture 220 defined by the first wing 216 of the nut plate base 210 and the aperture 222 defined by the second wing 218 of the nut plate base 210. It should be appreciated that both the movable threaded component 230 and the clip 240 can be formed from magnetic material. Despite the movable threaded component 230 and the clip 240 each being formed from magnetic material, systems for locating non-visible objects, such as the apparatus discussed above with reference to FIG. 3, cannot be used to locate the floating nut plate 200. As will be discussed below in more detail, fasteners according to the present disclosure can be used to affix magnetic targets associated with systems for determining location of non-visible objects to couple the magnetic target to the nut plate base 210. In this manner, systems for locating non-visible objects can locate the nut plate base 210 and, more specifically, the opening 215 defined by the nut plate base 210.

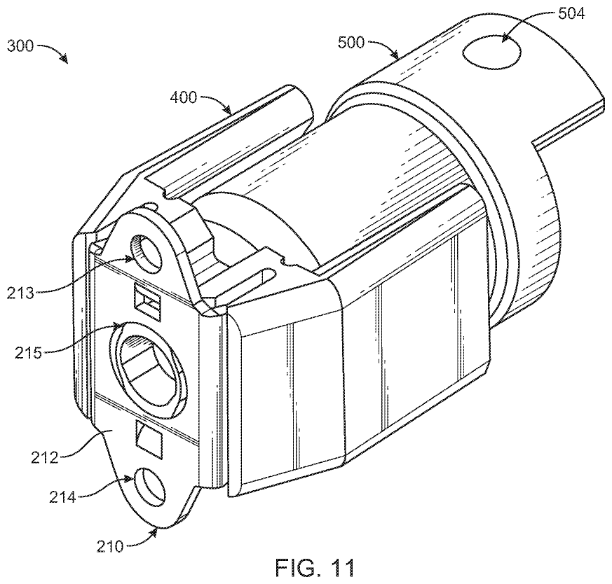

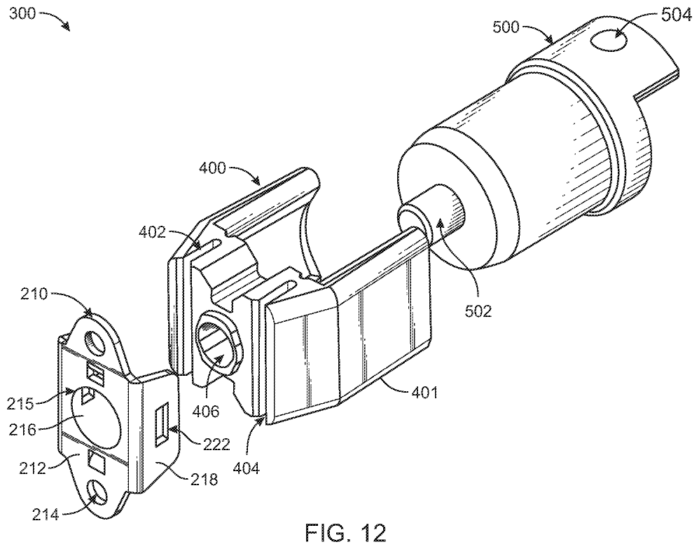

Referring now to FIGS. 11 and 12, a nut plate assembly 300 is provided according to example embodiments of the present disclosure. The nut plate assembly 300 can include the nut plate base 210 of the nut plate 200 discussed above with reference to FIG. 10. The nut plate assembly 300 can further include a fastener 400. As shown, the fastener 400 can include a body 3401. The body 401 can define a first slot 402 and a second slot 404 that is spaced apart from the first slot 402. In some implementations, a distance between the first slot 402 and the second slot 404 can correspond to a distance between the first wing 216 of the nut plate base 210 and the second wing 218 of the nut plate base 210. In this manner, the first wing 216 of the nut plate base 210 and the second wing 218 of the nut plate base 210 can be positioned within the first slot 402 and the second slot 404, respectively, when the fastener 400 is coupled to the nut plate base 210.

In some implementations, a portion of the body 401 defining the first slot 402 can include a projection (not shown) that can extend through the aperture 220 defined by the first wing 216. In this manner, the fastener 400 can be secured to the nut plate base 410 via the projection extending through the aperture 220 defined by the first wing 216. Alternatively or additionally, a portion of the fastener 400 defining the second slot 404 can include a projection (not shown) that can extend through the aperture 222 defined by the second wing 218. In this manner, the fastener 400 can be secured to the nut plate base 210 via the projection extending through the aperture 222 defined by the second wing 218.

When the fastener 400 is coupled to the nut plate base 210, it should be appreciated that an opening 406 defined by the body 401 of the fastener 400 can be aligned with the opening 215 defined by the body 212 of the nut plate base 210. It should also be appreciated that the fastener 400 can be formed from any suitable material. For instance, in some implementations the fastener 400 can be formed from a non-magnetic material. In some implementations, the non-magnetic material can be polyurethane. It should be appreciated, however, that the fastener 400 can be formed from any suitable non-magnetic material.

As shown, the nut plate assembly 300 can include a magnetic target 500 associated with a system for locating non-visible objects can be coupled to the nut plate base 210 via the fastener 400. For instance, the opening 406 defined by the fastener 400 can be configured to accommodate a portion of the magnetic target 500. In some implementations, the magnetic target 500 can include a projection 502 that can extend into the opening 406 defined by the fastener 400. In this manner, the projection 502 of the magnetic target 500 can be aligned with the opening defined by nut plate base 210 when the magnetic target 500 is coupled to the nut plate base 210 via the fastener 400. In some implementations, a shape of the projection 502 can correspond to a shape of the opening 406 defined by the body 401 of the fastener 400. As will be discussed below in more detail, a system for locating non-visible objects can locate the nut plate base 210 and, more specifically the opening 215 defined by the nut plate base 210 based on a magnetic field associated with the magnetic target 500 coupled to the nut plate base 210 via the fastener 400.

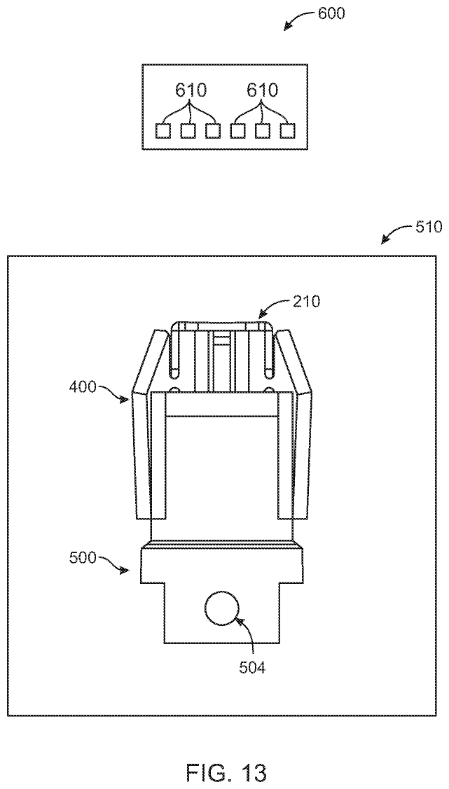

Referring now to FIG. 13, the nut plate base 210 can be disposed within a component 510 of an aircraft such that the nut plate base 210 is not visible outside of the component 510. For instance, the component 510 can be a wing of the aircraft. Alternatively, the component 510 can be a cowling or nacelle associated with a gas turbine engine mounted to the aircraft. It should be appreciated, however, that the component 510 can be any suitable component of the aircraft.

In some implementations, a system 600 for detecting non-visible objects, such as the apparatus discussed above with reference to FIG. 3, disposed outside the component 510 can locate the nut plate base 210 based, at least in part, on a magnetic field associated with the magnetic target 500 that is coupled to the nut plate base 210 via the fastener 400. More specifically, the system 600 can include an array of sensors 610 (e.g., Hall effect sensors) operable to detect the magnetic field associated with the magnetic target 500. When the system 600 determines the location of the nut plate base 210 and, more specifically the opening 215 defined by the nut plate base 210, a drilling guide tube, such as the drilling guide tube 33 of the apparatus discussed above with reference to FIG. 3, can be positioned on the exterior surface of the component 510 such that the drilling guide tube is aligned with the opening 215 defined by the nut plate base 210. In this manner, a hole can be drilled in the component 510 that is aligned with the opening 215 defined by the nut plate base 210.

In some implementations, a drill bit used to drill the hole in the component 510 can contact the magnetic target 500 and push the magnetic target 500 out of the opening 406 (FIGS. 11 and 12) defined by the body 401 of the fastener 400. More specifically, the drill bit can contact the projection 502 of the magnetic target 500 and push the projection 502 of the magnetic target 500 out of the opening 406. In such implementations, the magnetic target 500 can be coupled to a lanyard that can retain the magnetic target after it is decoupled from the fastener 400. For instance, the magnetic target 500 can define an opening 504 configured to accommodate the lanyard.

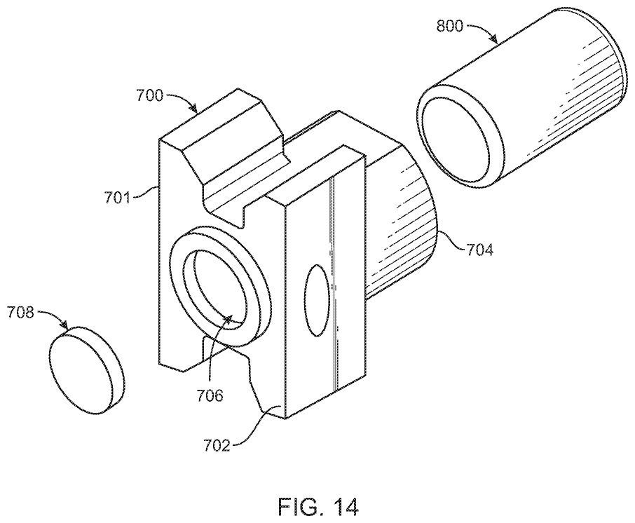

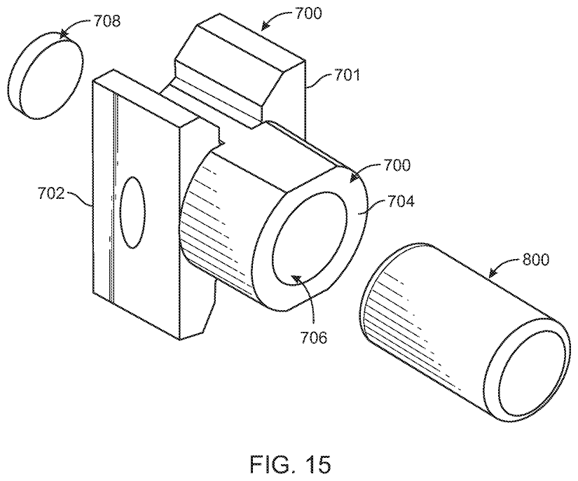

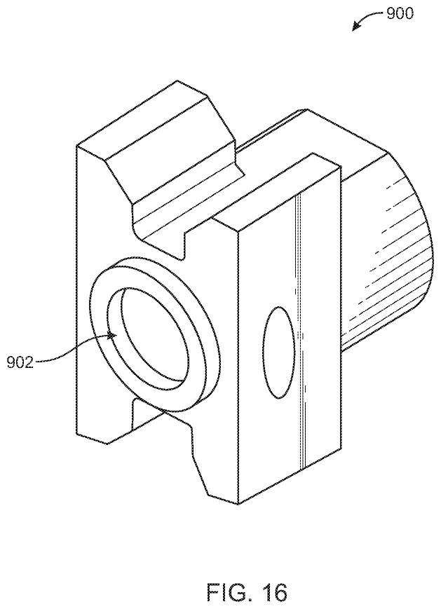

Referring now to FIGS. 14 and 15, another embodiment of a fastener 700 is provided in accordance with the present disclosure. As shown, the fastener 700 can include a body 701 extending between a first end 702 of the body 701 and a second end 704 of the body 701. Furthermore, the body 701 can define an opening 706 extending from the first end 702 of the fastener 700 to the second end 704 of the fastener 700. The fastener 700 can be configured to accommodate a magnetic target 800 associated with the system for detecting location of non-visible objects. As shown, the fastener 700 can include a cap 708 coupled to the body 701 such that the cap 708 covers the opening 706 at the first end 702 of the body 701. In this manner, the cap 708 can prevent a drill bit associated with a drill used to drill the hole in the component 510 from pushing the magnetic target 800 out of the opening 706 defined by the body 710. Accordingly, the magnetic target 800 does not need to be coupled to a lanyard like the magnetic target 500 discussed above with reference to FIGS. 11 through 13.

Referring now to FIG. 16, another fastener 900 is provided in accordance with the present disclosure. The fastener 900 of FIG. 16 can be configured in substantially the same manner as the fastener 700 discussed above with reference to FIGS. 14 and 15. However, in contrast to the fastener 700 of FIGS. 14 and 15, the magnetic target 902 is integrally formed with the fastener 900. In this manner, the magnetic target 902 can be directly coupled to the nut plate base 210 (FIG. 10).

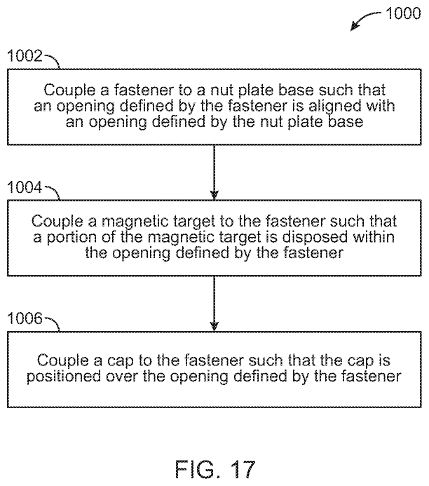

Referring now to FIG. 17, a method 1000 for coupling a magnetic target to a nut plate base is provided according to example embodiments. FIG. 17 depicts steps performed in a particular order for purposes of illustration and discussion. Those of ordinary skill in the art, using the disclosures provided herein, will understand that various steps of any of the methods disclosed herein can be omitted, rearranged, expanded, adapted, and/or modified in various ways without deviating from the scope of the present disclosure.

At (1002), the method 1000 can include coupling a fastener to the nut plate base such that an opening defined by the fastener is aligned with an opening defined by the nut plate base. In some implementations, coupling the fastener to the nut plate base such that the opening defined by the fastener aligned with the opening defined by the nut plate base can include coupling the fastener to the nut plate base such that a portion of the nut plate base is positioned within a slot defined by the fastener. For instance, in some implementations, the fastener can define a first slot and a second slot spaced apart from the first slot. More specifically, the second slot can be spaced apart from the first slot by a distance that corresponds to a distance between a first wing of the nut plate base and a second wing of the nut plate base. In such implementations, the fastener can be coupled to the nut plate base such that at least a portion of the first wing is received within the first slot and at least a portion of the second wing is received within the second slot.

At (1004), the method 1000 can include coupling the magnetic target to the fastener such that a projection of the magnetic target is disposed within the opening defined by the fastener. At (1006), the method 1000 can include coupling a cap to the fastener such that the cap is positioned over the opening defined by the fastener. In some implementations, the cap can be removably coupled to the fastener such that the cap is positioned over the opening defined by the fastener.

While the present subject matter has been described in detail with respect to specific example embodiments thereof, it will be appreciated that those skilled in the art, upon attaining an understanding of the foregoing may readily produce alterations to, variations of and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A fastener for coupling a magnetic target to a nut plate base, the fastener comprising:
a body defining an opening,
wherein when the magnetic target is coupled to the nut plate base via the fastener, the opening is aligned with an opening defined by the nut plate base and configured to accommodate a floating nut.

2. The fastener of claim 1, wherein when the magnetic target is coupled to the nut plate base via the fastener, a portion of the magnetic target is disposed within the opening defined by the body of the fastener.

3. The fastener of claim 2, wherein the portion of the magnetic target comprises a projection having a shape corresponding to a shape of the opening defined by the body of the fastener.

4. The fastener of claim 1, wherein the body further defines a first slot and a second slot, the second slot spaced apart from the first slot such that the opening defined by the body is positioned between the first slot and the second slot.

5. The fastener of claim 4, wherein when the magnetic target is coupled to the nut plate base via the fastener, a first wing of the nut plate base is disposed within the first slot and a second wing of the nut plate base is disposed within the second slot.

6. The fastener of claim 1, wherein the body of the fastener is formed from a non-magnetic material.

7. The fastener of claim 6, wherein the non-magnetic material comprises a polyurethane.

8. The fastener of claim 1, wherein the opening defined by the body of the fastener extends from a first end of the body to a second end of the body.

9. The fastener of claim 8, further comprising:
a cap coupled to the body such that the cap covers the opening at the first end of the body.

10. The fastener of claim 9, wherein the cap is removably coupled to the body of the fastener.

11. A method for coupling a magnetic target to a nut plate base, the method comprising:
coupling a fastener to the nut plate base such that an opening defined by the fastener is aligned with an opening defined by the nut plate base; and
coupling the magnetic target to the fastener such that a projection of the magnetic target is disposed within the opening defined by the fastener.

12. The method of claim 11, wherein coupling a fastener the nut plate base comprises:
coupling the fastener to the nut plate base such that a portion of the nut plate base is positioned within a slot defined by the fastener.

13. The method of claim 11, wherein the opening defined by the fastener extends from a first end of the fastener to a second end of the fastener.

14. The method of claim 13, further comprising:
coupling a cap to the fastener such that the cap covers the opening at the first end of the fastener.

15. A nut plate assembly, comprising:
a nut plate base defining an opening configured to accommodate a floating nut;
a fastener comprising a body defining an opening, the fastener removably coupled to the nut plate base such that the opening defined by the body thereof is aligned with the opening defined by the nut plate base; and
a magnetic target positioned within the opening defined by the fastener.

16. The nut plate assembly of claim 15, wherein the body further defines a first slot and a second slot, the second slot spaced apart from the first slot such that the opening defined by the body is positioned between the first slot and the second slot.

17. The nut plate assembly of claim 16, wherein a first wing of the nut plate base is disposed within the first slot and a second wing of the nut plate base is disposed within the second slot.

18. The nut plate assembly of claim 15, wherein the opening defined by the body extends from a first end of the body to a second end of the body.

19. The nut plate assembly of claim 18, wherein the fastener comprises a cap coupled to the body such that the cap covers the opening at the first end of the body.

20. The nut plate assembly of claim 15, wherein the magnetic target is integrally formed with the fastener.
